(19) United States
(12) Patent Application Publication
(10) Pub. No.: US 2012/0143842 A1
(43) Pub. Date: Jun. 7, 2012

(54) IMAGE ELEMENT SEARCHING

(75) Inventor: Randy Lacasse, Fairfax Station, VA (US)

(73) Assignee: CPA GLOBAL PATENT RESEARCH LIMITED, St. Helier (UK)

(21) Appl. No.: 13/390,059

(22) PCT Filed: Aug. 11, 2009
(86) PCT No.: PCT/US09/53378

§ 371 Date: Feb. 10, 2012

(51) Int. Cl. G06F 17/30

(52) U.S. Cl. 707/706; 707/E17.108

(57) ABSTRACT

A search platform that can search for and correlate elements in written and drawing portions of a document. The search engine can receive an indication of an element associated with a written portion of a document, determine a location in a drawing portion of the document associated with the element, and provide the determined location for display. Conversely, the search engine can also receive an indication of an element associated with a drawing portion of a document, determine a location in a written portion of the document associated with the element, and provide the determined location for display. Elements can refer to any textual, symbolic, or coded phrase or graphical representation associated with a unique alphanumeric or symbolic identifier in a written or drawing portion of a document or documents.

### FIELD OF THE DISCLOSURE

The disclosure of the present application relates to searching documents, including a search platform that can search for and correlate elements in written and drawing or graphical portions of a document or across multiple documents.

### BACKGROUND

The manner in which documents can describe subject matter is widely varied. In some situations, a document can describe one or more elements of a particular subject matter in different portions of the document, with each portion reflecting a distinct manner of presentation. For example, many patent documents (e.g., patents and published patent applications) include a written portion (referred to as a specification) and a drawing portion (referred to as drawings), and generally describe one or more elements in both their written portion and their drawing portion. The patent documents generally reference each element by an identifier, such as a numeral for example.

Patent applications submitted for examination before the a Patent and Trademark Office must meet certain requirements in order to issue as patents. For example, the subject matter claimed in the patent applications must be deemed new, useful, and non-obvious in the United States or be deemed useful with an inventive step in European offices. Similar standards are applied in patent offices around the world. To more effectively prepare a patent application for examination, it is useful to have knowledge of prior technical and patent documents in the same and related areas of technology. Conducting a patent search can be one way in which such “prior art” can be ascertained. The results of the patent search can help the drafter of a patent application focus on aspects that appear to be patentable subject matter and aid in developing a reasonable strategy for achieving the goals of the inventor or owner of the patent rights.

Prior to the evolution of technology in the current electronic information age, patent searches were conducted manually. A searcher would review a patent disclosure and conduct a paper search based upon a patent classification system. With the advent of information technology, paper search has given way to electronic search since most patents and published patent applications are available in electronic form. Unfortunately, although electronic search tools can provide search results much faster than a paper search, the tools provide minimal support in helping the patent searcher quickly and efficiently review and analyze the provided information.

In other industries, the search and display of information in text and graphical form can be highly useful in a variety of ways. Other applications such as technical and medical journals and books, magazines, advertisements, marketing materials, web sites, maps and charts, architectural or engineering papers and drawings, and instruction manuals use a combination of graphics and text to display information.

### SUMMARY

A search platform is disclosed that can search for and correlate elements in written and drawing or graphical portions of a document. By locating and correlating elements in written and drawing portions of a document, the search platform can enable users to quickly and efficiently review and analyze the elements in the context of the document. The methods and apparatus of the embodiments can be applied beyond the search and analysis of intellectual property. Any document that is, or has been converted to, electronic format could be searched and analyzed using the methods and apparatus described herein. Exemplary documents include technical and medical journals and books, magazines, advertisements, marketing materials, web sites, maps and charts, architectural or engineering papers and drawings, and instruction manuals.

In one embodiment, a search engine can receive an indication of an element associated with a written portion of a document, determine a location in a drawing portion of the document associated with the element, and provide the determined location for display. Conversely, the search engine can also receive an indication of an element associated with a drawing portion of a document, determine a location in a written portion of the document associated with the element, and provide the determined location for display.

The search engine can receive the indication in a variety of ways, such as via selection or rolling over of an element in the displayed document by a pointing device or via a document request specifying search terms. The search engine can identify elements in a document in any suitable manner. For example, elements can refer to any noun/noun phrase or graphical representation associated with a numeric or alphanumeric identifier in the written or drawing portion of a document, and the search engine can identify the elements through full text search and/or through optical recognition of the identifiers for example. The search engine can also provide functionality to locate and display sequential occurrences of elements in a particular portion of a document.

The determination of an element's location in a particular portion of a document can be performed in a variety of ways. In one embodiment, the search engine can determine the element's location by analyzing the particular portion of the document at the time the indication of the element is received. In another embodiment, the search engine can determine the element's location by analyzing stored metadata associated with the document, such as metadata stored in a data structure. In this embodiment, the metadata can be generated in advance the time the indication of the element is received, such as when a document collection comprising the document is compiled or indexed.

The search engine can display an indicated element location by highlighting any such text and/or reference identifier associated with the indicated element. Further, additionally indicated elements can be highlighted in different manners, such as with different colors for example. The manner in which the elements can be displayed in the drawing portion of a document can be widely varied. The search engine can highlight one or more of the text and/or reference identifier associated with the indicated element, the lead line emanating from such text and/or reference identifier, and any section of the drawing portion indicated by such lead line, such as any line that the lead line touches or any area surrounding or associated with the end of a lead line that does not touch a line, for example.

### BRIEF DESCRIPTION OF THE DRAWINGS

For a better understanding of the nature of the present invention, its features and advantages, the subsequent detailed description is presented in connection with accompanying drawings in which:

FIG. 1 illustrates an example of a search platform architecture;

FIG. 2 illustrates an example of a process for identifying elements in a drawing portion of a document;

FIG. 3 illustrates an example of a process for identifying elements in a written portion of a document;

FIG. 4 illustrates an example of a request screen for searching documents;

FIG. 5 illustrates an example of a process for searching a document collection;

FIG. 6 illustrates an example of a display screen identifying an element in a written portion of a document;

FIG. 7 illustrates an example of a display screen identifying an element in a written and drawing portion of a document;

FIG. 8 illustrates an example of a data structure associated with document metadata;

FIG. 9 illustrates an example of a process for associating elements in a written portion of a document with elements in a drawing portion of a document; and

FIG. 10 illustrates an example of a computing device capable of executing the systems and processes of the embodiments.

### DETAILED DESCRIPTION

The present disclosure is directed to a search platform that can search for and correlate elements in written and drawing portions of a document. By locating and correlating elements in written and drawing portions of a document, the search platform can enable users to quickly and efficiently review and analyze the elements in the context of the document.

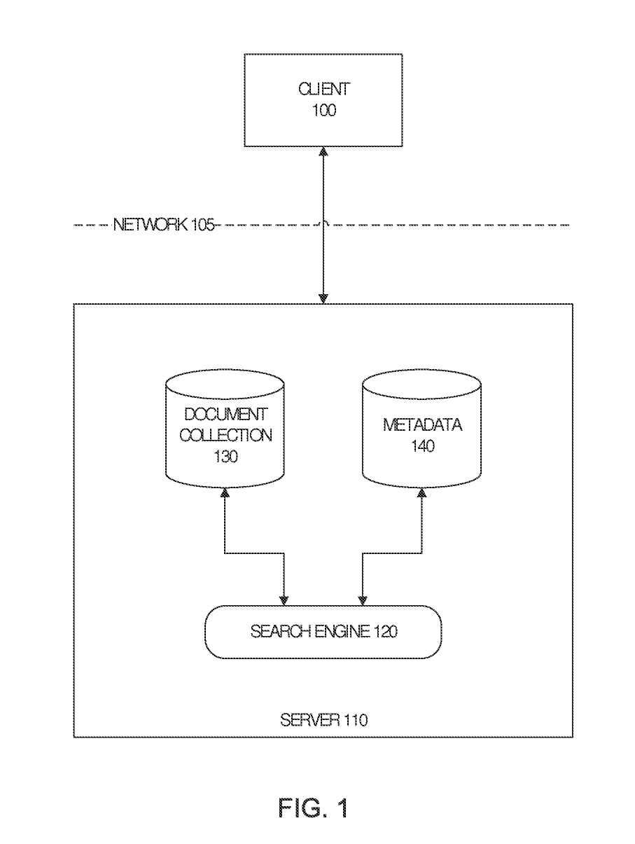

FIG. 1 illustrates an embodiment of a search platform architecture in accordance with the present disclosure. In the illustrated embodiment, a user operating client 100 can access server 110 across network 105. Server 110 can deploy search engine 120, which can be associated with document collection 130 and, in some embodiments, metadata 140.

Document collection 130 can include one or more databases storing documents. The documents can have different portions directed to representing information in different manners, such as a written portion (comprising text, paragraphs, headings, symbols, code, etc.) and a drawing portion (comprising images, illustrations, charts, graphics, maps, photos, diagrams, tables, etc.) or could be separate documents linking the written and drawing portions together by some type of reference or indicator. Exemplary documents held within the document database(s) includes documents that contains at least one figure, drawing, graphic, symbol, map, photo, diagram, charts, etc, (“drawing”) that have or could have explanatory text that is directed towards a portion of the drawing and somehow indicated in its corresponding location in the drawing and text. Exemplary documents can further comprise technical or medical journals, books, or papers, legal documents and opinions, magazines, advertisements, marketing documents, photographs, web pages, maps, architectural drawings, engineering drawings, process and operation manuals, and software manuals. In other embodiments, the documents can comprise legal documents, such as patents and/or patent publications for example, associated with one or more national patent office. Metadata 140 can include one or more databases storing data associated with the documents, such as a list of elements associated with each document and a list of locations in the each portion of each document associated with the elements for example. In one embodiment, the elements can correspond to subject matter of patent documents that is associated with a reference identifier such as a numeral or alphanumeric character(s).

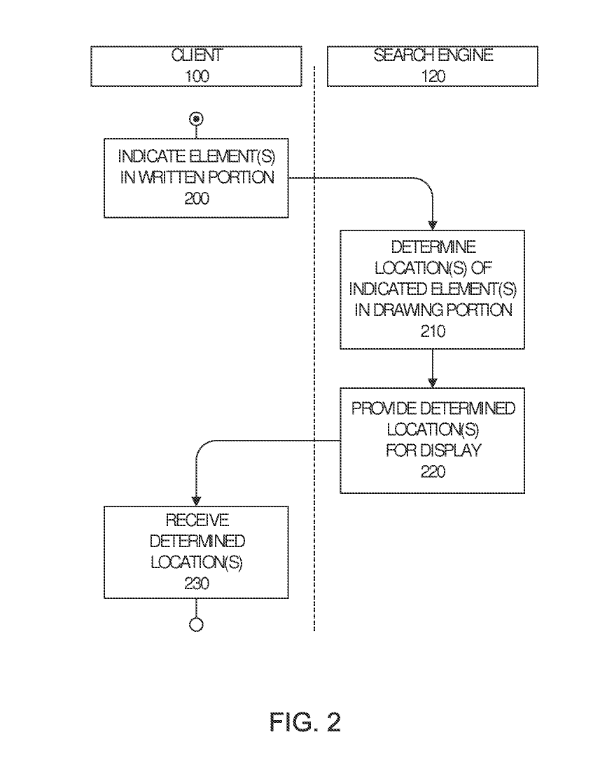

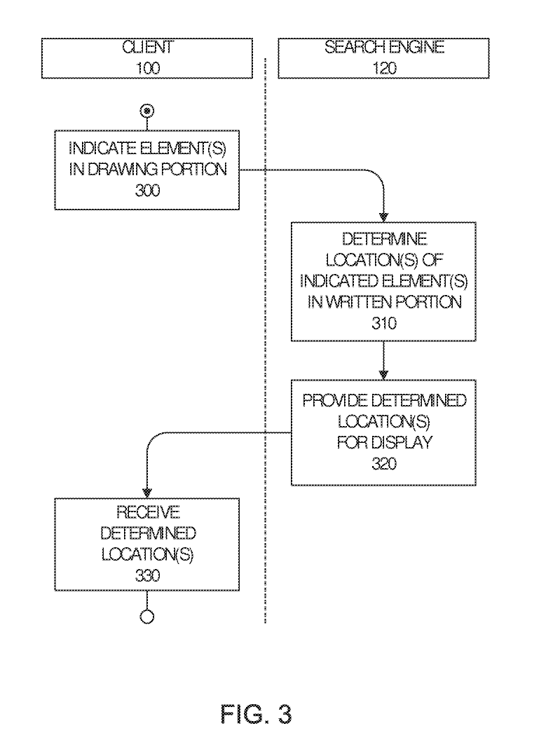

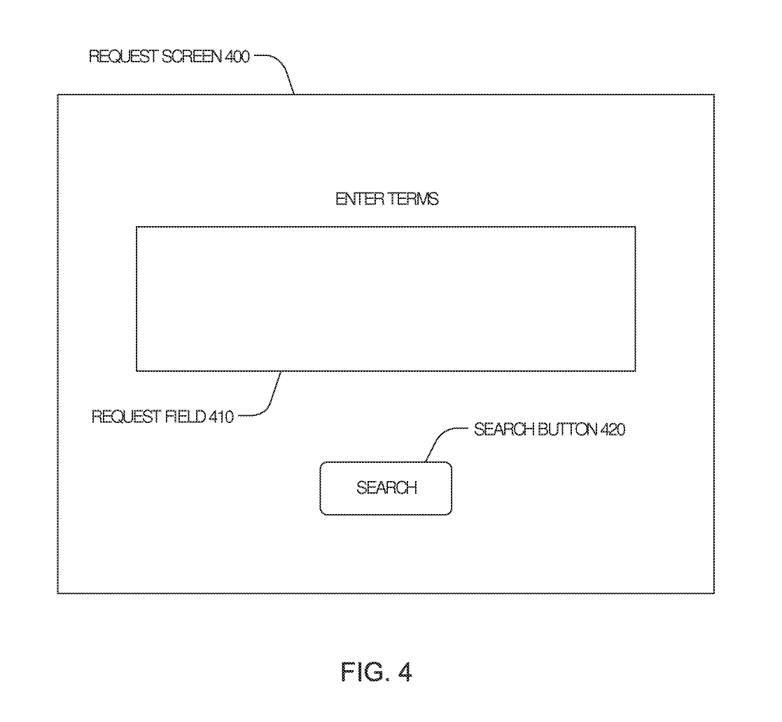

The ways in which search engine 120 can search for and identify elements located in different portions of documents can be widely varied. In some embodiments, as illustrated in FIGS. 2 and 3, search engine 120 can identify the location of elements in a first portion of a document based on an indication of the element by a user in the second portion of the document. In other embodiments, search engine 120 can identify the location of elements in portions of a document based on an indication of the element by a user in a search request, as illustrated in FIG. 4.

In the embodiment illustrated in FIG. 2, client 100 can provide (block 200) an indication of one or more elements associated with a written portion of a document to search engine 120. The indication can be provided by client 100 in any suitable manner. For example, in one embodiment the element can comprise text followed by a reference identifier, and the indication of the element can be provided by the selection or rolling over of the text and/or reference identifier with a selection mechanism that could include a mouse, a pointing device, keyboard strokes, stylus pen, etc., when displayed to client 100 in the written portion of the document.

In response to the indication, search engine 120 can determine (block 210) the one or more locations of the indicated element in the drawing portion of the document or the drawing portion of a second document. The manner in which the location can be determined can be widely varied. In one embodiment, for example, search engine 120 can determine the one or more locations on the spot by applying optical recognition to the drawing portion of the document. The optical recognition can seek the text and/or reference identifier associated with the indicated element, for example. In other embodiments, shapes of drawing elements or symbols can be identified and searched against an element database in an image matching process. Further, metadata or other types of tags could be associated with drawing elements and used to search a corresponding database linked to the tag. In other examples, patterns, shades, colors, or other graphical devices could be used to identify drawing elements.

Once the location of any elements in the drawing portion is determined, search engine 120 can provide (block 220) the determined location or locations to client 100 for display (block 230). The manner in which the elements can be displayed in the drawing portion can be widely varied. In one embodiment, for example, search engine 120 can display the one or more locations by highlighting any such text and/or reference identifier associated with the indicated element, the lead line emanating from such text and/or reference identifier and any line that the lead line touches, for example. In other embodiments, search engine 120 can highlight one or more of the text and/or reference identifier associated with the indicated element, the lead line or other identifier such as a link, electronic tag, or metadata emanating from or associated with such text and/or reference identifier, and any section of the drawing portion indicated by such lead line, such as any line that the lead line touches or any area surrounding or associated with the end of a lead line that does not touch a line. Additionally, indicated elements can be highlighted in different manners, such as with different color, shades, or patterns.

In the embodiment illustrated in FIG. 3, client 100 can provide (block 300) an indication of one or more elements associated with a drawing portion of a document to search engine 120. The indication can be provided by client 100 in any suitable manner. For example, in one embodiment the element can comprise text and/or a reference identifier, and the indication of the element can be provided by the selection or rolling over of the text and/or reference identifier by a selection mechanism such as a pointing device when displayed to client 100 in the drawing portion of the document.

In response to the indication, search engine 120 can determine (block 310) the one or more locations of the indicated element in the written portion of the document. The manner in which the location can be determined can be widely varied. In one embodiment, for example, search engine 120 can determine the one or more locations of the reference identifier and associated text by searching the text fields within the document or the text fields within a second document. In other embodiments the search engine 120 could apply optical recognition to the written portion of the document to look for any non-textual characters such as graphics, colors, symbols, photos, patterns, etc. The optical recognition can seek the text and/or reference identifier associated with the indicated element, for example. If a document has embedded metadata or tags, such devices could be searched for an identified in the document or its underlying coded portions as well.

Further, in other embodiments, in response to the indication, search engine 120 can determine (block 310) the one or more locations of the indicated element in the written portion of a database of other documents by using a combination of textual references to the element, an image query for graphical or image searching, or a combination of both to create a search query that can then be applied to other documents containing graphical and/or textual portions. Results of such a search would be the display of textual portions and/or drawing portions for each of the search results. Searches are executed according to the methods for searching as described herein.

Once the location of any elements in the written portion is determined, search engine 120 can provide (block 320) the determined location or locations to client 100 for display (block 330). The manner in which the elements can be displayed in the written portion can be widely varied. In one embodiment, for example, search engine 120 can display the one or more locations by highlighting any such text and/or reference identifier associated with the indicated element, for example. Additionally, indicated elements can be highlighted in different manners, such as with different colors, shades, patterns, or displayed in separate viewing areas on a computer screen.

FIG. 4 illustrates an embodiment of a request screen for searching documents and identifying correspond elements in the resulting documents. In the illustrated embodiment, request screen 400 comprises request field 410 and search button 420. Request field 410 can accept input constituting search terms from a user operating client 100. The input can include data such as words, phrases or other textual descriptions. Non-textual descriptions that could be input and searched include numbers, graphics, symbols, metadata, or tags. One skilled in the art will recognized that the listed examples are merely exemplary and other methods of input and searching within a document are not excluded from the scope of the embodiments. After the search terms have been entered into request field 410, the user can click search button 420, which can act as an instruction to search engine 120 to search for any documents and identify any corresponding elements in the documents associated with subject matter having similarity to the input search terms.

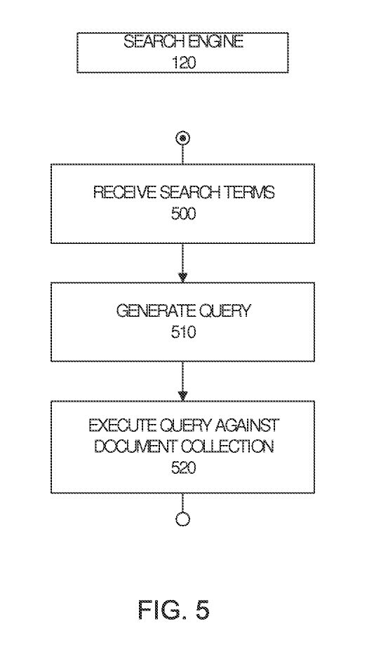

The ways in which search engine 120 can search a document collection, such as document collection 130 for example, can be widely varied. As illustrated in the embodiment of FIG. 5, for example, search engine 120 can receive search terms (block 500) provided through a user interface, such as request screen 400 for example. Search engine 120 can generate a query (block 510) based on the received search terms, and execute the query (block 520) against a document collection.

In one embodiment, for example, search engine 120 can employ a full text search methodology to identify any documents in the document collection that include any of the provided search terms. In another embodiment, search engine 120 can employ a vector based search methodology to identify any documents in the document collection that have a similarity to the provided search terms.

In an embodiment employing a vector based search methodology, search engine 120 can create a document vector for the query generated based on the received search terms. For example, the document vector can be a weighted list of words and phrases, such as:
[table, 1][chair, 0.5][plate, 0.2]
   as a simplified example. Once the query document vector is created, search engine 120 can compare the query document vector with retrieved document vectors that have been previously created for each of the documents to be searched in document collection 130. The comparison can include, for example, multiplying the weights of any common terms among the query document vector and each retrieved document vector, and adding the results to obtain a similarity ranking. Taking another simplified example:
query document vector: [table, 1][chair, 0.5][plate, 0.2]
retrieved document vector: [cup, 1][saucer, 0.7][chair, 0.6][plate, 0.5]
similarity=0.5*0.6+0.2*0.5=0.4
   If the similarity ranking exceeds a predefined threshold, search engine 120 can consider the document associated with the retrieved document vector to be a match.

In the vector based search methodology described above, each document stored in document collection 130 can be associated with one or more document vectors. For example, since documents such as patent documents, for example, usually have a defined number of sections for meeting statutory filing requirements, a distinct document vector can be created for each section of a patent document, enabling search engine 120 to tailor a search on specific sections of the patent document. Further, the document vectors can be adjusted to remove non-relevant words or phrases among the provided search terms to yield a smaller and more concise document vector, which can improve efficiency of query processing due to time not spent by search engine 120 processing the removed strings.

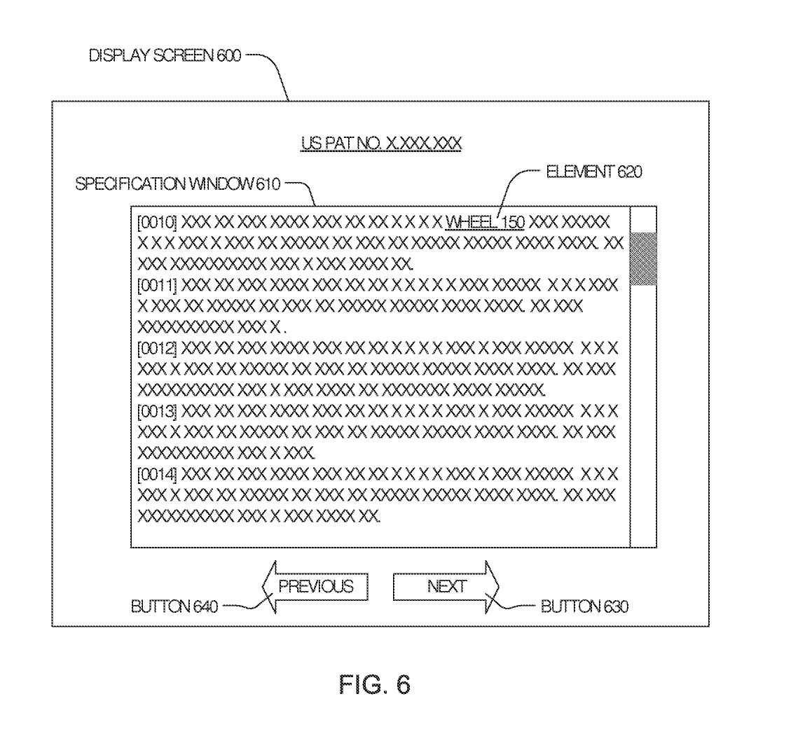

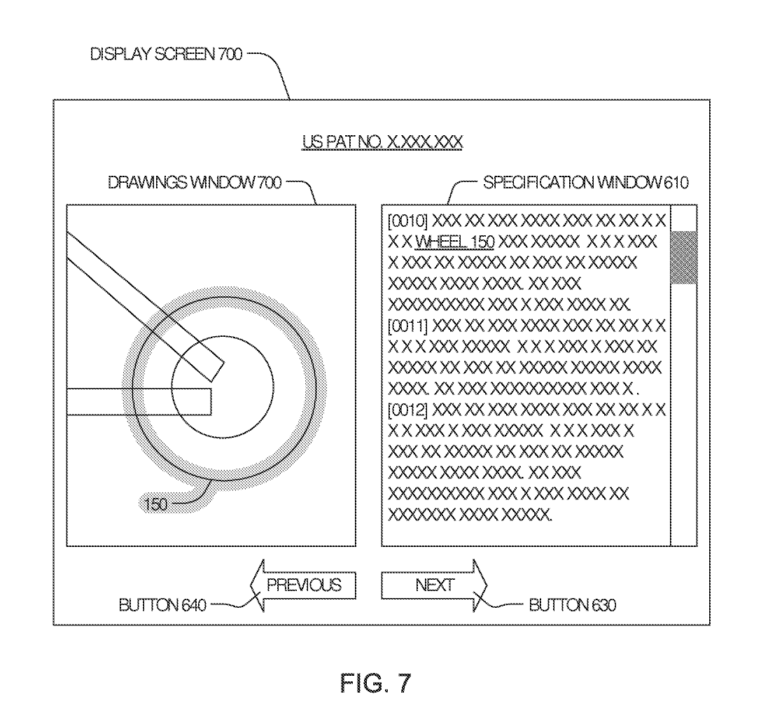

FIG. 6 illustrates an embodiment of a display screen identifying a document that can be displayed by search engine 120. In the illustrated embodiment, display screen 600 comprises specification window 610 that displays to client 100 the written portion of a patent document. Search engine 120 can also provide functionality in connection with elements in the written portion, such as displayed element 620 (“wheel 150”) for example, to enable the user to locate such elements in the drawing portion of the document as illustrated in FIG. 7 in connection with element 620. This functionality can be widely varied as described above in connection with FIG. 2.

For example, in one embodiment, the functionality can be based on a click input event. In this embodiment, the elements can be presented in the displayed written portion as clickable links, such that, upon selection by a selection mechanism such as a pointing device associated with client 100, any location of the selected element in the drawing portion of the document can be provided for display (in accordance with block 220 for example). In another embodiment, this functionality can be based on a rollover input event. In this embodiment, the elements can be presented in the displayed written portion such that, upon positioning near to or rolling over an element by a selection mechanism associated with client 100, any location of the rolled-over element in the drawing portion of the document can be provided for display (in accordance with block 220 for example).

FIG. 7 illustrates an embodiment of a display screen identifying an element in a written and drawing portion of a document. In the illustrated embodiment, upon receiving an indication of element 620 (according to block 200 for example) in specification window 610, search engine 120 can provide drawings window 700 to identify the indicated element in the drawing portion of the document. Although the embodiment illustrated in FIG. 7 identifies the indicated element in drawings window 700 by highlighting a reference identifier (e.g., “150”) associated with the indicated element, the lead line emanating from the reference identifier and the line that the lead line touches, the manner in which the indicated element can be identified can be widely varied as described above.

The manner in which the drawing portion can be displayed with the written portion can be widely varied. For example, drawings window 700 can be provided adjacent to specification window 610 in display screen 600 as illustrated in the embodiment of FIG. 7. In another embodiment, search engine 120 can provide drawings window 700 in an overlapping manner with specification window 610 in display screen 600, such as in mouseover windows/bubbles for example. In a further embodiment, search engine 120 can provide drawings window 700 in a different screen than display screen 600.

Further, in accordance with FIG. 3, search engine 120 can display the drawing portion of the document, receive an indication of an element in the drawing portion by the user, and locate and identify to the user the indicated element in the written portion of the document in a similar manner as described above. And in accordance with the embodiment associated with FIG. 4, search engine 120 can provide a display screen, in response to a request specifying search terms, identifying one or more elements matching the specified search terms in the written and/or drawing portion of documents found in a similar manner as described above.

Search engine 120 can also provide functionality to locate and display sequential occurrences of elements in a window in focus. The manner in which this functionality can be implemented can be widely varied. In one embodiment, for example, this functionality can be implemented through the use of find next and find previous buttons, such as buttons 630 and 640, respectively, as illustrated in FIGS. 6 and 7 for example. This functionality can locate and display sequential occurrences of a particular highlighted element or any element in a window.

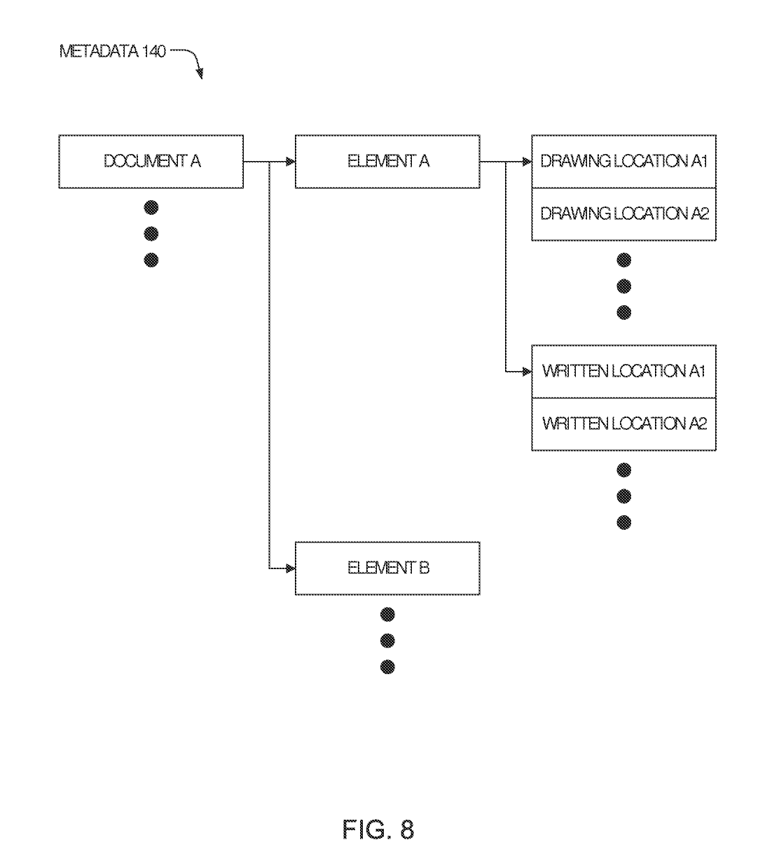

The determination of an element's location in a particular portion of a document can be performed in a variety of ways. In one embodiment, for example, search engine 120 can determine the element's location by analyzing the particular portion of the document at the time the indication of the element (e.g., user selection of the element in the displayed document or document request based on search terms) is received. In another embodiment, search engine 120 can determine the element's location by analyzing stored metadata associated with the document, such as metadata stored in a data structure as illustrated in FIG. 8 for example. In this embodiment, the metadata can be generated in advance of a user selecting an element in a displayed document or requesting documents based on search terms, such as when document collection 130 is compiled or indexed.

FIG. 8 illustrates an embodiment of a data structure associated with document metadata. In the illustrated embodiment, metadata 140 can comprise document data, element data, drawing location data and written location data. The document data can identify a document in document collection 130 for example. The element data can be associated with the document data, and can identify one or more elements in a written and/or drawing portion of the document. The drawing location data and written location data can be associated with the element data, and can identify the drawing and written location, respectively, of the corresponding element in the drawing and written portions of the associated document.

For example, in the embodiment illustrated in FIG. 8, document A can identify a document in document collection 130. Elements A, B and C can be associated with document A via a pointer or other suitable data structure mechanism, and can identify distinct elements in a written portion of document A. Drawing locations A1 and A2 can be associated with element A via a pointer or other suitable data structure mechanism, and can identify a location of element A in a drawing portion of document A. Similarly, written locations A1 and A2 can be associated with element A via a pointer or other suitable data structure mechanism, and can identify a location of element A in a written portion of document A. Element B can have no association with drawing or written location data, meaning that the element B may not be represented in the written or drawing portion of document A. The consecutive dots can indicate that any number of documents and elements can be represented in this manner.

Although document collection 130 and metadata 140 are shown as distinct databases in the embodiment illustrated in FIG. 1, in other embodiments the data embodied in document collection 130 and metadata 140 can be stored together in one or more databases or other suitable storage medium.

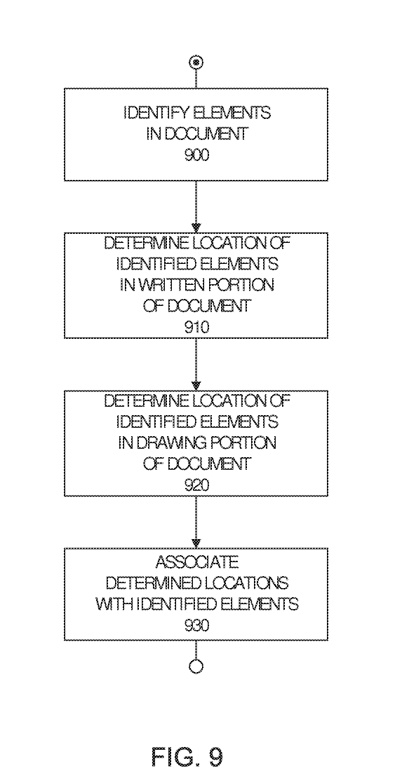

FIG. 9 illustrates an embodiment of a process for associating elements in a written portion of a document with elements in a drawing portion of a document. This process can be performed by a processing unit to enable construction of the data structure illustrated in FIG. 8 for example. In the embodiment illustrated in FIG. 9, a processing unit can identify (block 900) elements in a document in any suitable manner. In one embodiment, for example, elements can refer to any noun/noun phrase or graphical representation associated with a reference identifier such as a numeral or set of alphanumeric characters in the written or drawing portion of a document, and the processing unit can identify the elements through full text search and/or through optical recognition of the reference identifiers for example. Once or as the elements of the document are identified, the processing unit can determine the location of the identified elements in the written portion of the document (block 910) and the drawing portion of the document (block 920). Location information determined by the processing unit can comprise any suitable data to reflect which portion of the document is associated with an identified element. Once the location information is determined, the processing unit can associate (block 930) the determined locations with their corresponding identified elements, such as in the form of a data structure as illustrated in FIG. 8 for example.

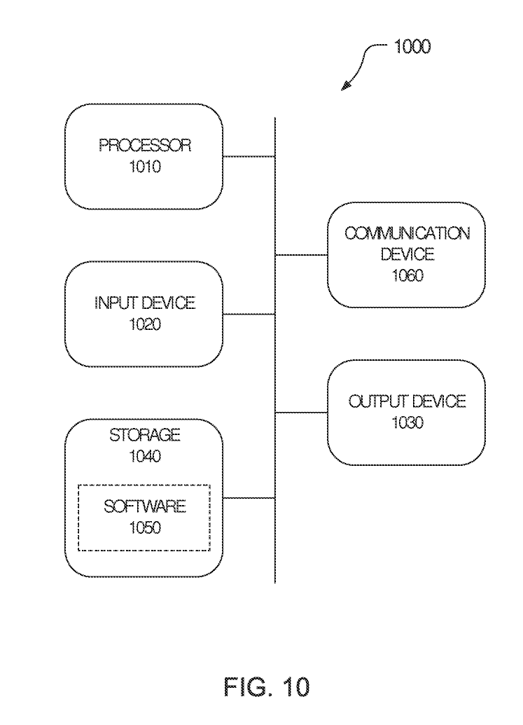

FIG. 10 shows a block diagram of an example of a computing device, which may generally correspond to client 100 and server 110. The form of computing device 1000 may be widely varied. For example, computing device 1000 can be a personal computer, workstation, server, handheld computing device, or any other suitable type of microprocessor-based device. Computing device 1000 can include, for example, one or more components including processor 1010, input device 1020, output device 1030, storage 1040, and communication device 1060. These components may be widely varied, and can be connected to each other in any suitable manner, such as via a physical bus, network line or wirelessly for example.

For example, input device 1020 may include a keyboard, mouse, touch screen or monitor, voice-recognition device, or any other suitable device that provides input. Output device 1030 may include, for example, a monitor, printer, disk drive, speakers, or any other suitable device that provides output.

Storage 1040 may include volatile and/or nonvolatile data storage, such as one or more electrical, magnetic or optical memories such as a RAM, cache, hard drive, CD-ROM drive, tape drive or removable storage disk for example. Communication device 1060 may include, for example, a network interface card, modem or any other suitable device capable of transmitting and receiving signals over a network.

Network 105 may include any suitable interconnected communication system, such as a local area network (LAN) or wide area network (WAN) for example. Network 105 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 1050 can be stored in storage 1040 and executed by processor 1010, and may include, for example, programming that embodies the functionality described in the various embodiments of the present disclosure. The programming may take any suitable form. For example, in one embodiment, programming embodying the document collection search functionality of search engine 120 can be based on an enterprise search platform, such as the Fast Enterprise Search Platform by Microsoft Corp. for example.

Software 1050 can also be stored and/or transported within any computer-readable storage medium for use by or in connection with an instruction execution system, apparatus, or device, such as computing device 1000 for example, that can fetch instructions associated with the software from the instruction execution system, apparatus, or device and execute the instructions. In the context of this document, a computer-readable storage medium can be any medium, such as storage 1040 for example, that can contain or store programming for use by or in connection with an instruction execution system, apparatus, or device.

Software 1050 can also be propagated within any transport medium for use by or in connection with an instruction execution system, apparatus, or device, such as computing device 1000 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system comprising:
a search engine executed by a microprocessor and configured to
receive an indication of an element associated with a written portion of a document,
determine a location in a drawing portion of the document or of a second document associated with the element, and
provide the determined location for display.

2. The system of claim 1, wherein the search engine is configured to receive the indication of the element by receiving a selection by a selection mechanism of the element displayed in the written portion.

3. The system of claim 1, wherein the search engine is configured to receive the indication of the element when a pointing device is positioned over the element in the written portion.

4. The system of claim 1, further comprising the search engine is configured to search a document database for other drawing portions based on the drawing portion associated with the element that is associated with the written portion.

5. The system of claim 1, wherein the document comprises a legal document, and
wherein the search engine is configured to receive the indication of the element by receiving a request for identifying the element to search a legal document collection.

6. The system of claim 1, wherein the search engine is configured to determine the location in the drawing portion by analyzing the drawing portion of the document in response to receiving the indication of the element.

7. The system of claim 1, wherein the search engine is configured to determine the location in the drawing portion by analyzing stored metadata associated with the document or the second document.

8. The system of claim 1, wherein the element is associated with a reference identifier, and the search engine is configured to determine the location by searching the drawing portion for the reference identifier.

9. The system of claim 1, wherein the search engine is configured to provide the determined location for display in a separate window than one in which the written portion of the document is displayed.

10. The system of claim 1, wherein the search engine is configured to provide the determined location for display by highlighting the element in the drawing portion.

11. The system of claim 1, wherein the document is a patent or patent application.

12. A system comprising:
a search engine executed by a microprocessor and configured to:
receive an indication of an element associated with a drawing portion of a document,
determine a location in a written portion of the document or a second document associated with the element, and
provide the determined location for display.

13. The system of claim 12, wherein the search engine is configured to receive the indication of the element by receiving a selection by a pointing device of the element displayed in the drawing portion.

14. The system of claim 12, wherein the search engine is configured to receive the indication of the element when a pointing device is positioned over the element in the drawing portion.

15. The system of claim 12, further comprising:
the search engine configured to search a document database for other drawing portions based on the drawing portion associated with the element that is associated with the written portion.

16. The system of claim 12, wherein the document comprises a legal document, and
wherein the search engine is configured to receive the indication of the element by receiving a request for identifying the element to search a legal document collection.

17. The system of claim 12, wherein the search engine is configured to determine the location in the written portion by analyzing the written portion of the document in response to receiving the indication of the element.

18. The system of claim 12, wherein the search engine is configured to determine the location in the written portion by analyzing stored metadata associated with the document.

19. The system of claim 12, wherein the element is associated with a reference identifier, and the search engine is configured to determine the location by searching the written portion for the reference identifier.

20. The system of claim 12, wherein the search engine is configured to provide the determined location for display in a separate window than one in which the drawing portion of the document is displayed.

21. The system of claim 12, wherein the document is a patent or patent application.

22. A method, comprising:
identifying, by a processing unit executed by a microprocessor, an element in a document;
determining, by the processing unit, a location in a written portion of the document associated with the identified element;
determining, by the processing unit, a location in a drawing portion of the document associated with the identified element, and
storing, by the processing unit, an association between the identified element and the determined locations in a memory.

23. The method of claim 22, wherein the element is associated with a reference identifier, and the processing unit determines the locations by searching the written and drawing portions for the reference identifier.

24. A computer-readable storage medium encoded with a data structure comprising:
first data identifying a document;
second data associated with the first data, the second data identifying an element referenced in the document;
third data associated with the second data, the third data identifying a location in a first portion of the document associated with the element; and
fourth data associated with the second data, the fourth data identifying a location in a second portion of the document or a portion in a second document associated with the element.

25. The computer-readable storage medium of claim 24, further comprising:
fifth data identifying search results of other drawing portions from a document database that are located based on the drawing portions in the third data.

26. The computer-readable storage medium of claim 24, wherein the element is associated with a reference identifier.

27. A computer-readable storage medium storing instructions executable by a computer to:
execute a search engine that is configured to:
receive an indication of an element associated with a written portion of a document,
determine a location in a drawing portion of the document or of a second document associated with the element, and
provide the determined location for display.

28. A computer-readable storage medium storing instructions executable by a computer to:
execute a search engine that is configured to:
receive an indication of an element associated with a drawing portion of a document,
determine a location in a written portion of the document or a second document associated with the element, and
provide the determined location for display.
